(19) United States
(12) Patent Application Publication
(10) Pub. No.: US 2024/0323094 A1
(43) Pub. Date: Sep. 26, 2024

(54) COMPONENT-BASED METHOD FOR WORST-CASE ANALYSIS FOR STREAM-BASED SCHEDULING, CLASS-BASED SCHEDULING AND FRAME PREEMPTION IN TIME-SENSITIVE NETWORKS

(71) Applicants: HIRSCHMANN AUTOMATION AND CONTROL GMBH, Neckartenzlingen (DE); UNIVERSITÄT STUTTGART, Stuttgart (DE)

(72) Inventor: David HELLMANNS, Stuttgart (DE)

(21) Appl. No.: 18/281,604

(22) PCT Filed: Apr. 21, 2022
(86) PCT No.: PCT/EP2022/060617

§ 371 Date: Sep. 12, 2023

(30) Foreign Application Priority Data
Apr. 22, 2021 (DE) 10 2021 110 266.9

(51) Int. Cl. H04L 41/14; H04L 41/12

(52) U.S. Cl. CPC H04L 41/145; H04L 41/12

(57) ABSTRACT

A method for improving time planning in time-critical networks is proposed. This is done by means of a computer network with a plurality of network users. To carry out the method, all network users along a transmission path from a network user functioning as a transmitter to a network user functioning as a receiver are first detected. Once these network users are known, the longest possible transfer time for a data stream between any two network users along the transmission path is calculated according to an interference model or an end-to-end model. The longest possible transfer time between a transmitter and a receiver is then calculated by summing the calculated transfer times. This transfer time between the transmitter and the receiver that is calculated in this way can then be taken as a basis for the time planning in the network.

The present invention relates to a component-based method for worst-case analysis for stream-based scheduling, class-based scheduling and frame preemption in time-sensitive networks.

First, we define the system considered in this application, including the relevant TSN network components, mechanisms, and essential assumptions. We then represent how we model the delay of a stream from the source to the destination. In order to show that our delay model is useful, we discuss the delay-causing components of terminals and switches. Our switch and forwarding model follows the IEEE standards.

We model the topology as a directed graph ç−(V, E). The nodes (V) designate terminals and switches. Edges ((V0, V1)∃E|V0, V1εV) describe the output ports. Therefore, in our graph, each Ethernet link is shown as two unidirectional links. We refer to the set of all streams s e s, which is a tuple describing the properties of the stream: namely stream ID (S_{id}), traffic class (S_{pcp}), source (S_{source}εV), Destination (S_{target}εV), path (Sₚₐₜₕ=((S_{source}, V₁ . . . , (Vₙ₋₁, S_{target}))) and frame size (S_{size}ε[64, 1500]) in bytes.

Next, we provide our delay model based on the delays of a stream between S_{source} and S_{target}. In the description of the delay model, we distinguish between end hosts (S_{source}, S_{target}), and intermediate hops (switches). We model only network delays and, therefore, do not account for any application delays to S_{source} and S_{target}, we assume that the source hosts have a suitable mechanism for sending the streams to the scheduled transmission time,

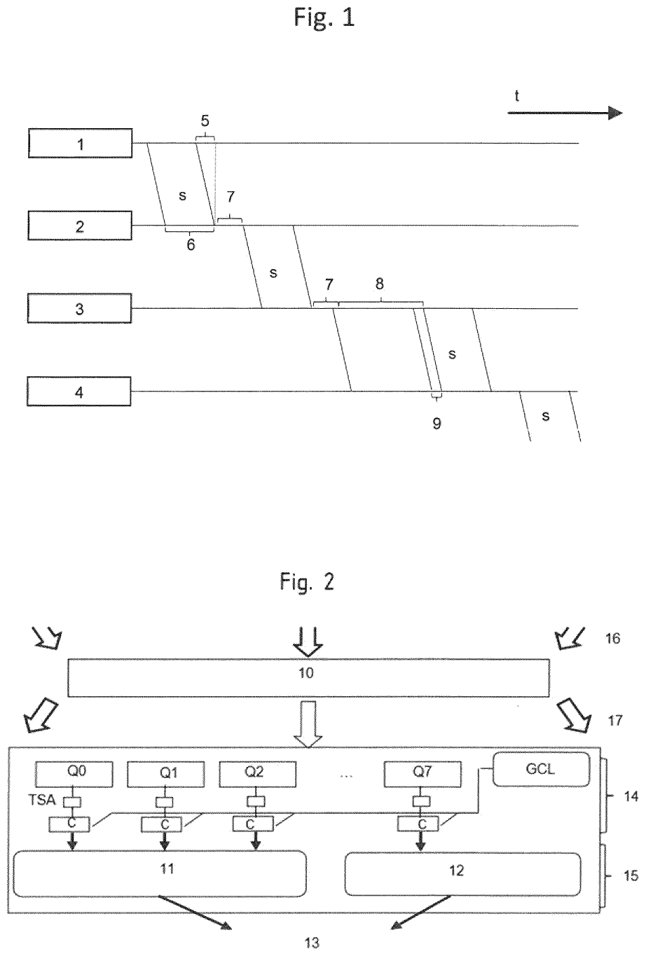

Intermediate hops must receive, process and forward the frame to the next hop, FIG. 1 gives an overview of the delays discussed below on the basis of data streams of a plurality of network users 1, 2, 3, 4. The reception of the frames includes the propagation delay 5 and the transmission delay 6. The propagation delay 5 describes the time t between the transmission of a signal on the transmitting side and the reception of this signal on the receiving side. The resulting propagation delay 5 is dependent on the signal propagation speed within the connecting medium (e.g. copper, glass fiber) and the length of the connection. To simplify our model, we assume that propagation delay 5 is given as an edge property: dₚᵣₒₚ(e), εE. The transmission delay 6 indicates the time t between the reception of the first bit and the last bit of the frame at the receiver. It is therefore dependent on the connection speed and the size of the frame. We assume that the link_speed is as the edge property is given as: (link_speed (e), εE, (M_{bit}/S). Therefore we calculate the transmission delay 6 as follows:

$$( {d}_{t r a n s} ( e , size = ( ( size / 8 ) / link\_speed ( e )$$

In order to increase the time that a frame blocks a connection, it is not sufficient to consider only dₜᵣₐₙₛ(e, size) since Ethernet specifies what is referred to as Inter-Frame Gap (IFG). The IFG indicates how long the link 13 must pause between two consecutive transmissions, e.g. 12 B or 96 ns at 1 Gbit/s.

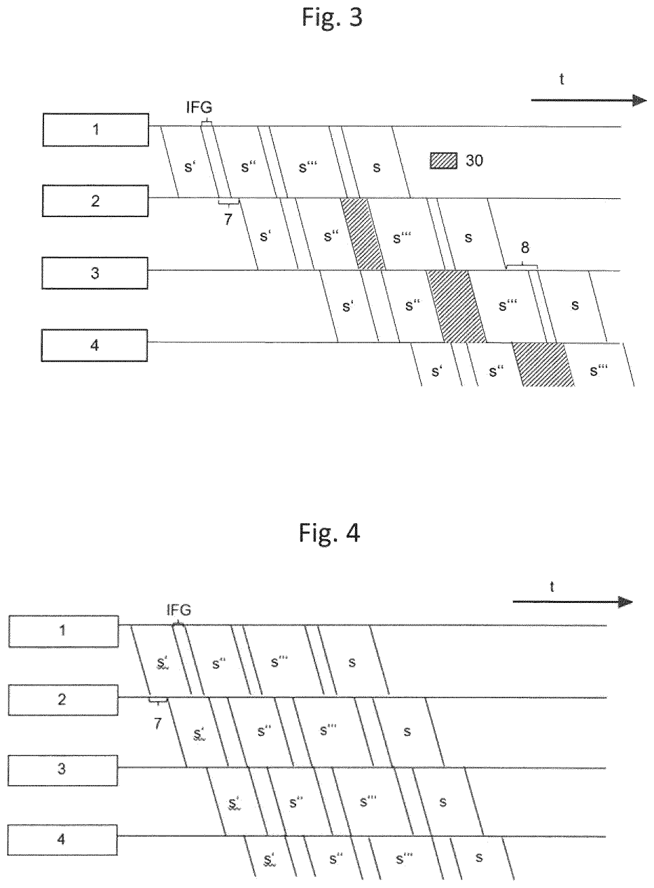

The beginning of the next steps depends on the switch behavior. In this case, a switch is a special network user. Here, we distinguish two types of behavior: lEEE-compliant store-and-forward (see FIG. 3) and cut-through-forwarding (see FIG. 4). Store-and-forward behavior means that the switch obtains the complete frame before beginning to process it. In contrast, in cut-through forwarding, the switch waits only for the reception of the frame header before it begins processing. By way of example, we assume that the switch must receive the first 24B, consisting of preamble and Ethernet header including the VLAN tag, In addition, we use the so-called delayed cut-through mechanism, i.e. if a frame has to wait due to a blocked output port, the transmission of the frame begins immediately when as the output port is released again. In contrast, other cut-through implementations assume that, when the frame cannot be directly forwarded, resort is made to a store-and-forward behavior for that frame on the current switch.

After reception, the frame passes through various processing stages in the exchange, e.g. filtering, statistics acquisition and forwarding. In FIG. 2, we show our simplified switch model reduced to the relevant components for the delay calculation, including switch logic 10 with input points (input) 16. Since the processing stages of a switch are generally implemented in hardware, the resulting delay is practically constant, so that we can assume a maximum value. We refer to this delay as processing delay 7 and model it as a vertex property: d_{proc}(V), VεV. In the relay stage, the switch reads the destination address and VLAN tag of the frame to determine the output port 17. Each output port 17 contains up to eight output queues Q0 . . . Q7. Based on the PCP (Priority Code Point) value in the VLAN tag of the frame and a configured assignment, the switch assigns the frame to one of the output queues Q0 . . . Q7. Each of the output queues Q0 . . . Q7 has a transmission selection algorithm (TSA) and a gate c. The TSA determines whether the queue contains a frame that is eligible for transmission. Known TSA implementations are strict priority and credit-based shaper (CBS). In this work, we use the strict priority mechanism that always returns a frame when the queue is not empty. This mechanism is called Strict Priority Queuing because the combination of this mechanism with a Transmission Selection (TS) requesting the queues in descending priority is called to select the highest nonempty queue. Thus, if the TS selects a low-priority frame just before a high-priority frame arrives, the low-priority frame delays the high-priority frame in the worst case by the transmission delay of a maximum size frame.

In order to improve the worst-case delay estimation, the IEEE has standardized the Time-Aware Shaper (TAS). The above-mentioned gates c are the core components of the TAS. Each queue has a gate c that separates the ISA from the TS. An open gate releases the corresponding queue while a closed gate blocks the queue. Thus, only frames of released queues are eligible for transmission. To change the gate states, the switches use the gate control list (GCL). The GCL entries are tuples consisting of an interval and a gate state. The interval determines the duration for which the indicated gate state is valid. Blocking low priority queues for a particular time prevents high-priority frames from being disturbed by low-priority frames. The configuration of the GCL thus essentially corresponds to the configuration of the TDMA. In order to prevent overshooting of transmissions in a gate-closed interval, a frame is only made eligible for transmission when the end of the transmission is guaranteed before the gate is closed. There are two strategies to determine whether a frame can be transmitted before the gate is closed. On the one hand, so-called guard bands are defined. A guard band is as long as the time required to transmit a frame of the MTU size. This guard band is preceded by the gate close event and a start of transmission within the guard band is denied. Therefore, no frame may be in transmission when the gate closes. Second, the length-aware scheduling (LAS) prevents the start of transmission of a frame that cannot be terminated prior to closing the gate. LAS checks the frame length and denies transmission when the transmission would extend into the next gate interval. Guard bands are easy to implement and can also be used when the frame size is not known at the beginning of the transmission (e.g. at cut-through switching), while LAS requires more logic, but uses the available bandwidth more efficiently.

In addition to TAS, Frame Preemption (FP) 15 is another lEEE mechanism to reduce the effects of low-priority frames on high-priority frames. To configure FP, priorities are distinguished in express priorities and preemptable priorities. Frames with express priority can interrupt the transmission of frames with preemptable priority. After transmission of the express frame, the interrupted transmission of the preempted frames continues where it has been interrupted. However, frames cannot be preempted at any position. For this purpose, the TS is decomposed into a preemption part 11 and an express part 12.

Fragments must be at least 64 B long, therefore units of 123 B or less must not be interrupted or preempted. We refer to this 123 B as a minimum fragmentable unit (MFU). As a result, the worst case inference between an express frame and a preemptable frame corresponds to the transmission delay of 123 B. FP and TAS may be combined or used as a single function.

In order to return to our delay definitions, we refer to queue delay 8 between the end of processing and the beginning of the transmission of the frame as d_{queue} (see FIG. 1). The delays defined above occur on each intermediate step. After the last transmission on the connection between the last intermediate hop and S_{target}, no processing delay 7 occurs, since the processing is the responsibility of the application which does not fall within our area. In summary, we express the delay experienced by a data stream on its path from S_{source} via the intermediate stations as a sum of dₜᵣₐₙₛ, dₚᵣₒₚ, d_{proc} and d_{queue}.

The object of the present invention is therefore to provide a method to detect and, if necessary, predict possible delays in the data traffic of the network early in time-sensitive networks.

These features are solved by the main claim and thus the provision of a worst-case analysis.

Before beginning with the introduction of the formal model to describe stream interferences, we explain how frames sharing edges of their paths behave over multiple edges. From these findings we derive a formula to describe the worst-case interference of a particular stream. Thereafter, we apply our model to stream-based scheduling, class-based scheduling, and FP, how a mixture behaves from these scrubbing methods.

### A. Interference Model

In order to derive our worst-case formula for interference between streams, we begin with a very simple scenario: We consider a line topology in which the switches have a store-and-forward behavior and all links have the same link speed. All streams begin at one end of the line and are targeted at the other end of the line topology. Thus all streams share the same path. In the following descriptions, we always consider the worst-case scenario for a particular stream s.

1) Store-and-forward Interference Model: In view of the given scenario, we ask how the interference looks in the worst case. As described in section I, only d_{gueue} models the influence of other streams, in which section we focus only on the interference of streams and, since d_{queue} also includes the delay caused by closed gates, if a plurality of frames compete for the same transmission path, we set a new delay, i.e. a contention situation occurs.

Consequently, if the contention is maximum around the connection, the case is only if all frames arrive at the same time or all frames in the moment are in the queue in which the gate opens. The last frame in the queue experiences the highest delay since it must wait until all other frames have been transmitted. Due to the fact that all frames share the same path, this situation can occur only at the leading edge, since simultaneous arrival is only possible if the inflow is much higher than the outflow, e.g. on the host on which the frames are generated or when the frames arrive via different ports. In this case, it should be noted that Ethernet does not allow nonstop transmission of frames, and we therefore have to add to an IFG per competing stream (see section 1).

After we have viewed the first hop, we now concentrate on the next hop. Here, the situation depends on the speed of the Δₚₒₛ frames. We use the physical definition of speed: Δₚₒₛ/Δₜᵢₘₑ. For our case, we have Δₚₒₛ=1 (hop) and Δₜᵢₘₑ=dₜᵣₐₙₛ (e, S_{size}). Since we assume the same connection speed on all edges, we can formulate dₜᵣₐₙₛ independently of e. As a result, we can further simplify the expression, to 1/dₜᵣₐₙₛ(S_{size}) which leads to the discovery that small frames move faster than large frames. If the frames are smaller than or equal to the last frames, they move at the same or even faster speed from hop to hop, Consequently, the last frame from the first hop experiences no further delays in the queue at the next hop. However, if at least one preceding frame is larger and therefore moves more slowly, subsequent frames on the next hop must again wait for the slower frame (queue). In this case, the waiting time is the difference of dₜᵣₐₙₛ between the slowest frame and the last frame, since the speed on the path is determined by the slowest frame. This situation repeats on all remaining hops until the last frame reaches the destination node. We represent the scenario described by way of example in FIG. 3. In summary, the following formula can be derived for the worst-case interference of a stream s, assuming that s is the last stream that stands on the first hop:

$${d}_{interference}^{s} \leq {\underbrace{{\sum }_{{s}^{′} ∈ S \backslash s} {d}_{t r a n s} ( {s}_{size}^{′} + IFG )}}_{queuing on first hop} + {\underbrace{{\sum }_{e ∈ {S}_{path} \backslash {S}_{path} [ 0 ]} {d}_{t r a n s} ( {max}_{{s}^{′} ∈ S} ( {s}_{size}^{′} ) - {s}_{s i z e} )}}_{queuing on remaining path}$$

The formulation for the queue on the remaining path also applies if s is the largest frame:

S_{size}=max_{(s′εS)}(S^{r}_{size})=d(ₜᵣₐₙₛ)(S_{size}−S_{size})=0.

In the second component of the above equation, we conclude the leading edge of the path of s since the leading edge is covered in the first component of the equation.

Proceeding from the above equation, we can expand our scenario by cancelling the constraint that all frames will focus on the same host. Since all frames still start at the same host, the first component d^{s}_{interference} remains unaffected. We change the second component to reflect that not all frames need to share the entire path of s and therefore need only be taken into account until they exit the path of s: For this purpose, we need only adjust the area of the max operator:

$${γ}_{interference}^{s} \leq … + {\underbrace{{\sum }_{e ∈ {S}_{path} \backslash {S}_{path} [ 0 ]} {d}_{t r a n s} ( {max}_{{s}^{′} ∈ S \vert e ∈ {s}_{path}} ( {s}_{size}^{′} ) - {s}_{s i z e} )}}_{queuing on remaining path}$$

Please note that we evaluate the max operator on each edge because the largest competing frame on the leading edge can exit the path of s and thus competes for the following edges s with other frames.

Next, we loosen the restriction that all frames begin on the same node. Consequently, we have to consider our assumption that old frames in the queue are upstream of stream s on the source host. Reverting to the basic idea: Stream s waits on the source host until all frames have been transmitted in front of it in the queue, and on the subsequent hops only to the difference of dₜᵣₐₙₛ. If not, all other frames are already on the source host before stream s, the frames are injected anywhere on the path. This leads us to the question: what is the worst case injection of frames for the transmission of stream s? The greatest interference between two streams (s, s′) occurs when s has to wait for the entire transmission of s′. This is illustrated in FIG. 3 on the basis of a plurality of data streams s, s′, s″, s′″. This situation occurs if s′ is queued shortly before the arrival of s into the data queu. Heretofore, we have assumed that this situation always occurs at the leading edge of the path of s(ₚₐₜₕ[0]) since all streams start at the same source. In the following we do not know which edge of the overlapping edges is that of s or another stream s′. Thus we propose the binary relation first_overlapping edgeₛ(f_o_eₛ), that contains all streams s′ that intersect at with the path of s and the leading edge of the overlapping path segments:

$$S \times ε = \{ ( {s}^{′} , e ) : {s}^{′} ∈ S ⋀ {s}_{path}^{′} ∩ {s}_{p a t h} \neq ∅ , e = ( {s}_{path}^{′} ∩ {s}_{p a t h} ) [ 0 ] \}$$

With f_o_es, we can now change the range of the max operator, and we can add the leading edge of Sₚₐₜₕ to the area of the sum operator since filtering is performed with f-o-es:

$${d}_{interference}^{s} \leq … + {\underbrace{{\sum }_{e ∈ {s}_{path}} {d}_{trans} ( {{max}_{{s}^{′} ∈ S \vert e ∈ {s}_{path}}}_{⋀ ( {s}^{′} , e ) ∉ f\_o {\_e}_{s}} ( {s}_{size} ) - {s}_{size} )}}_{queuing on remaining path}$$

Finally, we generalize our scenario to any topologies. This relaxation has no consequences for stream s, since the path of a stream can be considered a line topology. For our consideration, this means that no other streams must conflict with stream s, i.e. the streams have no common edges. Hence we modify d^{s}_{interference} such that streams are only considered that have at at least one edge in common with stream S. To simplify the use of this expression in the following, we propose a function α_{sf}:

$${α}_{s f} ( s , S ) := {\underbrace{{{\sum }_{{s}^{′} ∈ S ∖ s}}_{\vert \vert {s}_{path}^{′} ⋂ {s}_{path} \vert > 0} {d}_{trans} ( {s}_{size}^{′} + IFG )}}_{waiting for all frames once} + {\underbrace{{\sum }_{e ∈ {S}_{p a t h}} {d}_{t r a n s} ( {{max}_{{s}^{′} ∈ S \vert e ∈ {s}_{path}}}_{⋀ e ∉ f\_o {\_e}_{s}} ( {s}_{size}^{′} ) - {s}_{size} )}}_{queuing on remaining path} {d}_{interference}^{s} \leq {α}_{sf} ( s , S )$$

Having derived this formula, we see the question of whether there is another scenario that is still worse. We currently assume that all frames are injected directly in front of the considered frame and thereby cause a maximum delay of the considered frame. If this were not the worst case, this would mean that we would have to wait for unknown frames, which contravenes our assumption that we are aware of all the traffic in the network. In addition, we have simulated all permutations of frames in multiple scenarios and the worst permutations corresponded to the equation for function α_{sf}.

2. Cut-through Interference Model: In the previous scenario, we assume that the switches implement a store-and-forward behavior. In this section we discuss which adjustments are required to model the properties of cut-through forwarding.

As described above in section 1, a switch begins with active cut-through forwarding with the processing of the frame after the header has been received. Since the header is of constant size, the frame size function dₜᵣₐₙₛ only occurs on the leading edge. In the following hops, stream s experiences only a constant dₜᵣₐₙₛ (header_size). If the per-hop delay is no longer frame size-dependent, the speed of the frames is independent of the frame size, and thus we can ignore the corresponding component in our interference model. As with the store-and-forward interference model we perform a function α_{ct} to simplify the use of this expression in the following:

$$\begin{matrix}{α}_{c t} ( s , S ) := {\underbrace{{{\sum }_{{s}^{′} ∈ S ∖ s}}_{\vert \vert {s}_{path}^{′} ⋂ {s}_{path} \vert > 0} {d}_{trans} ( {s}_{size}^{′} + IFG )}}_{waiting for all frames once} \\ {d}_{interference}^{s} \underline{<} {α}_{c t} ( s , S )\end{matrix}$$

Since we want to model both types of forwarding behavior, we use in the following a to emphasize that the formula is for both store-and-forward as well as for cut-through. For the concrete calculation it must then be replaced by α_{sf} or α_{ct},

### B. End-to-End Delay Model

The end-to-end delay (dₑ₂ₑ) of a stream from the source host (S_{source}) to the target host (S_{target}) is first composed of the physical path delay (dₚₐₜₕ) and the variable delay (d_{queue}). The components of the path delay are dₜᵣₐₙₛ, d_{Pmp}, d_{proc} (see section 1). With this definition, we mean the end-to-end delay of a stream s as:

$${d}_{e 2 e} = {d}_{p a t h}^{s} + {d}_{q u e u e}^{s}$$

The path delay depends only on sₚₐₜₕ and S_{size}. Therefore, we can calculate the path delay for each stream and treat them in the following as a constant. In contrast, the queue delay is not constant and depends on the configuration of the gates and the interference of stream s with other streams. In particular, frames are waiting in an output queue of a switch when the gate of the queue is closed or the connection is occupied by other frames. To model these two factors, we define the queue delay as follows:

$${d}_{queue}^{s} = d {+}_{gate}^{s} + {d}_{interference}^{s}$$

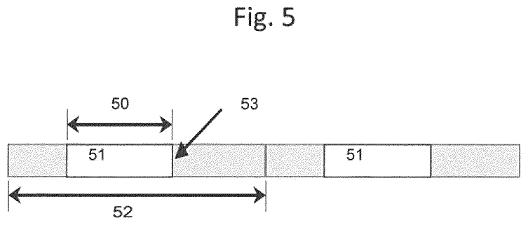

The definition of d^{s}_{gate} is configuration-dependent. If we have no knowledge of the time when the transmitter sends the stream, we can derive the worst case for d^{s}_{gate} by evaluating how long the gate is closed for the priority of stream s. The more we know about the time of transmission of the stream, the narrower we can set the worst case boundary for d^{s}_{gate} (see FIG. 5). We show various ways to calculate this delay when we discuss the various scheduling methods.

The interference delay also depends on the scheduling method, but we can formulate an abstract formula that applies in all cases when the subcomponents are appropriately modeled. We distinguish two types of interference, namely intraclass interference and interclass interference. As interclass interference, we refer to the queue delay caused by the transmission of frames that belong to the same traffic class as the stream s. Class interference refers to the delay which is caused by frames of other traffic classes.

$${d}_{interference}^{s} = {d}_{intraclass}^{s} + {d}_{interclass}^{s}$$

To express the intraclass interference, we calculate the worst case queue for stream s taking into account all other streams of the traffic class of the stream.

For interclass interference, we distinguish between streams of higher priority traffic classes (d_{interclass}, >) and streams of lower priority traffic classes (d_{interclass}<)

$${d}_{interclass}^{s} = {d}_{interclass}^{s} + {d}_{interclass}^{s} , <$$

All higher priority streams are privileged to stream s and therefore the transmission of stream s is delayed by the transmission of all higher priority streams.

$${d}_{interclass}^{s} = α ( s , \{ {s}^{′} ε S \vert {s}^{′} , pce > s . pcp \} )$$

In addition, the switch stream s preferably treats stream s with lower priority streams, causing stream s to wait for the frame. In the worst case, the transmission has just begun and the frame has the maximum size. As a result, our stream must respond to all higher priority streams and wait for a low-priority frame with maximum size on each hop of path sₚₐₜₕ.

$${d}_{inter ‐ class , <}^{s} = {\sum }_{e ∈ {s}_{path}} {d}_{trans} ( e , MTU + IFG )$$

We can better estimate the upper limit if we have knowledge of the lower priority streams i by considering the largest lower priority frame on each edge:

$${d}_{i n t e r c l a s s , <}^{s} = {\sum }_{e ∈ {s}_{path}} {max}_{{{s}^{′} ∈ S \vert e ∈ {s}_{path}}_{⋀ {s}^{′} . pcp < s . pcp}} {d}_{t r a n s} ( e , {s}_{size}^{′} + IFG )$$

Here, too, we consider the assumption that our formula describes the worst case. We assume that s has to wait for all streams with higher or equal priority and on each hop to the largest stream with lower priority. A further delay of s could occur only if another stream blocked the connection. This would mean that we do not know all streams of higher and equal priority or another lower priority frame is preferred, which would mean that the frame arbitration of the switch is not functioning correctly. The only other way of delaying transmission would be a closed transmission gate that we model in d_{gate}.

After the introduction of our general stream interference model, we apply the model to the various implementations of scheduling in TSN networks, namely stream-based scheduling, class-based scheduling, and FP. In order to apply the model, we found several different values of d_{queue}, while dₚₐₜₕ remains unchanged, since it depends only on the switch behavior and the path. The results of using our model on each of the scheduling approaches shows that our model is also capable of calculating the worst-case end-to-end delay (dₑ₂ₑ) for combining these approaches.

### A. Stream-Based Scheduling

Stream-based scheduling is a scheduling approach in which a dedicated time slot is reserved for each stream. This scheduling approach is well explored, since the worst-case behavior is easy to calculate. In particular, no interference with other streams can occur due to the reservation of dedicated time slots. However, stream-based scheduling requires a very precise time synchronization of old devices in the network and the capability of the terminals to send the streams exactly at the scheduled time. Moreover, the calculation of an optimal schedule for the streams is an NP-heavy problem.

By reserving a dedicated time slot for each stream, the scheduled streams do not wait because of closed gates in the queue, since the GCL is calculated so that the dedicated time slot is reserved for each stream, the gates open upon arrival of the stream and close after the transmission of the stream. Therefore, we can neglect d_{gate} for stream-based scheduled streams.

d^{s}_{gate}=0

If no-wait schedules are used, there is also no queue for s, since the dedicated time slot also includes interference from stream s with streams of the same traffic class as well as streams of other stream classes.

$${d}_{interference} = {{d}^{s}}_{intraclass} + {{d}^{s}}_{interclass} = 0$$

Consequently, the end-to-end delay of stream-based, time-controlled streams depends only on the path delay.

$${d}_{e 2 e}^{S} = {d}_{path}^{S} + {\underbrace{{d}_{q u e u e}^{S}}}_{= 0} = {d}_{p a t h}^{S}$$

Thus, if a stream-based scheduling algorithm utilizes queues, that is, no-wait is not implemented, the scheduler d_{queue} must compute and consider it accordingly.

### B. Class-Based Scheduling

In contrast to stream-based schedule, class-based scheduling does not consider individual streams within the same stream class but instead considers all the streams in the same stream class. For this purpose, the gates of the traffic class under consideration are opened once for a certain time in cycle 52 (see reference 51 in FIG. 5). We refer to this opened interval as a t_{window} 50. For class-based scheduling, we assume that the hosts behave cyclically, but the cycle 52 does not have to match the network cycle. This means that our model can check whether a given t_{window} is sufficient to guarantee a particular dₑ₂ₑ or to calculate a t_{window} for a given dₑ₂ₑ.

The gate delay for a stream is maximum when the stream arrives at 53 that the remaining gate open time is not just sufficient to transmit the frame. Consequently, the stream must wait until the gate opens again in the next cycle (see FIG. 5). For d_{gate}, we distinguish two cases (see Section 1), namely the use of Guard Band (following first equation) or Length-Aware Scheduling (LAS) (second equation below):

$$\begin{matrix}{d}_{g a t e}^{s} \leq {t}_{cycle} - ( {t}_{window} + {max}_{e ∈ {s}_{path}} ( {d}_{trans} ( e , {s}_{size} - 1 ) ) ) \\ {d}_{g a t e}^{s} \leq {t}_{cycle} - ( {t}_{window} + {max}_{e ∈ {s}_{path}} ( {d}_{trans} ( e , M T U ) ) )\end{matrix}$$

Within the gate open period, stream s competes with all other streams belonging to the same traffic class in the worst case, since the hosts are not tuned to the network cycle. Thus, there is no time offset between streams belonging to the same traffic class:

$${d}_{i n t e r c l a s s}^{s} \leq α ( s , \{ {s}^{′} ε S \vert {s}^{′} . pcp = s . p . cp \} )$$

In the case of interclass interference, we distinguish two cases, namely that the traffic class of stream s uses exclusive gating, which means that only the gate of the traffic class is opened by stream s, and nonexclusive gating means so that multiple gates may be open simultaneously. If exclusive gating is used, interference may not occur between different classes, since access to the connection for other classes is not granted within the window:

d^{s}_{interclass}=0

Otherwise, nonexclusive gating means that there may be interference between the streams of traffic classes whose gates are open simultaneously. If gates of higher priority classes are opened as the class of stream s, then in the worst case we must wait for all streams of these traffic classes:

$${d}_{i n t r a c l a s s}^{s} \leq α ( s , \{ {s}^{′} ε S \vert {s}^{′} . pcp = s . p . c p \} )$$

In this case, the formula does not differ for both d^{s}_{interclass} and d^{s}_{intraclass}. In contrast to d^{s}_{interclass}, we need only ensure the streams of lower priority that, on every edge of the biggest frame, lower priorities are downstream.

$${d}_{n t e r - c l a s s , <}^{s} = {\sum }_{e ∈ {s}_{path}} {{max}_{{s}^{′} ∈ S \vert e ∈ {s}_{path}^{′}}}_{⋀ {s}^{′} . pcp < s . pcp} {d}_{t r a n s} ( e , {s}_{size}^{′} + IFC )$$

If we do not have knowledge of the lower priority traffic, we assume a MTU size frame as the upper bound.

The following formulas describe the worst-case end-to-end delay of class-based streams.

$${d}_{e 2 e}^{S} = {d}_{path}^{S} + {d}_{g a t e}^{S} + {\underbrace{α ( s , \{ {s}^{′} ∈ S \vert {s}^{′} . pcp > s . pcp \} ) +}}_{{d}_{inter - c l ass , >}^{s}} {\underbrace{α ( s , \{ {s}^{′} ∈ S \vert {s}^{′} . pcp == s . pcp \} )}}_{{d}_{intra - class}^{s}} + {\underbrace{{\sum }_{e ∈ {s}_{path}} {{max}_{{s}^{′} ∈ S \vert e ∈ {s}_{path}^{′}}}_{⋀ {s}^{′} . pcp < s . pcp} {d}_{t r a n s} ( e , {s}_{size}^{′} + IFC )}}_{{d}_{inter - class , <}^{s}}$$

### C. Frame Preemption

Frame Preemption (FP) is a scheduling approach that differs significantly from the approaches based on Time-Aware Shapers (TAS), since no exclusive time windows can be reserved for certain traffic classes. In order to configure FP, traffic classes are marked as express or preemptable. The transmission selection (TS) favors frames of the express traffic classes over preemptable traffic classes. In addition, the priority within the express traffic classes and within the preemptable classes is based on the PCP mapping. In summary, it can be said that FP is easier to configure, but FP can only distinguish two priority classes, and we cannot grant exclusive access to certain traffic classes.

Proceeding from our general formula, we can neglect d^{s}_{gate} since we do not have a gating.

$${d}_{e 2 e}^{S} = {d}_{path}^{S} + {\underbrace{{d}_{gate}^{S}}}_{= 0} + {d}_{intra - class}^{S} + {d}_{inter - class}$$

We need not adjust our formula for class-like interference since the worst case for stream s is still that s is the last stream in the queue. However, for interclass interference, we need to add an additional level since we are between express traffic and preemptable traffic and priorities within the express traffic classes and preemptable traffic classes must be distinguished. If we mark for example traffic class (TC) 7 and TC 6 as express, stream s of TC 7 cannot get ahead of transmission of stream s′ of TC 6 and therefore, in the worst case, must wait for an MTU-size frame. However, if stream S of TC 5 marked as preemptable is undergoing transmission, s will interrupt the transmission of s″. Although both streams, s′ and s, have a lower priority, the behavior is different due to the additional priority level. In order to take into account the additional priority level, we subdivide d^{s}_{interclass} into d^{s}_{interclass,<e} that handles the delay of the express traffic class and d^{s}_{intercias<p} to handle the delay of the preemptable traffic classes:

$${d}_{inter - class}^{s} = {d}_{inter - c l ass , >}^{s} + {\sum }_{e ∈ {s}_{path}} max ( {d}_{inter - class}^{s} , {<}_{e} ( e ) + {d}_{inter - c l ass , {<}_{p}}^{s} ( e ) )$$

We signal the maximum of ds_{interclass<p} and d^{s}_{interclass, <e} on every edge because s can only be delayed by a frame of lesser priority. In order to model the worst case, we presume that this delay is formed by the largest possible frame. For d^{s}_{interclass, <e} we take the biggest low-priority express stream:

$${d}_{inter - class}^{S} = {d}_{inter - c l ass , >}^{S} + {\sum }_{e ∈ {s}_{path}} max ( {d}_{inter - class}^{S} , {<}_{e} ( e ) + {d}_{inter - c l ass , {<}_{p}}^{S} ( e ) )$$

By contrast, we limit the preemptable delay through the MFU by

$${max}_{{{s}^{′} ∈ S \vert e ∈ {s}_{path}^{′}}_{{⋀ {s}^{′} . pcp < s . pcp}_{⋀ {s}^{′} . pcp ∉ Express}}} {d}_{t r a n s} ( e , MFU + IFG )$$

The following formula drawn from the discussed aspects is given for the worst case end-to-end delay using FP:

$${d}_{e 2 e}^{S} = {d}_{path}^{S} + {\underbrace{α ( s , \{ {s}^{′} ∈ S \vert {s}^{′} . pcp > s . pcp \} ) +}}_{{d}_{inter - class , >}^{S}} {\underbrace{α ( s , \{ {s}^{′} ∈ S \vert {s}^{′} . pcp == s . pcp \} )}}_{{d}_{intra - class}^{S}} + {\sum }_{e ∈ {s}_{path}} max ( {d}_{inter - class , {<}_{e}}^{S} ( e ) , ( {d}_{inter - class , {<}_{p}}^{S} ( e ) )$$

In connection with the cut-through forwarding, it is important to note that cut-through can only be used for express classes. Preemptable stream classes may not use cut-through since the decision as to whether a preemptable frame can be preempted is based on the size of the remaining fragment. When using cut-through, the remaining size cannot be determined if the frame has not yet been completely received. Thus, at this time, it is not critical whether the remaining bytes of the frame are sufficient to form a fragment (see MFU).

### D. Combination of Scheduling Schemes

After we have applied our model individually to the various scheduling approaches, we consider combinations of the scheduling approaches and show how we can model the influence of the scheduling approaches to each other. We discuss in the following each of the scheduling approaches and show what influence the other approaches and mechanisms have on the worst-case model of the stream considered approach. We begin with the stream-based scheduling,

1. Stream-based scheduling: Stream-based scheduling implements a strict temporal and spatial isolation of the planned streams. Therefore, stream-based scheduled streams require exclusive gating that protects its streams from interference with class-based scheduled streams or FR. Due to the protection, no changes are required in our model. However, this protection has effects on the other mechanisms discussed below.

2. Class-based scheduling: Class-based scheduling also uses gating, but may be configured to be less stringent than stream-based scheduling. If we use class-based scheduling with exclusive gating, streams of other classes may not affect the class being considered. Without exclusive gating, interference between the classes must be taken into account (see Equation for page 16).

If we combine class-based scheduling and stream-based scheduling, the worst-case behavior does not change since stream-based scheduled streams are isolated such that they are not with class-based, scheduled streams that may interfere with each other. Therefore, this combination behaves like class-based scheduling with exclusive gating.

The combination of class-based scheduling without exclusive gating and FP may result in interference. If the class-based streams are marked preemptable (see equation on page 16) otherwise applies. Otherwise, the worst case improves since class-based streams may occur to other streams and thus to d^{s}_{interclass, <} is reduced in an MFU per edge:

$${d}_{e 2 e}^{S} = {d}_{p a t h}^{S} + {d}_{g a t e}^{S} + {\underbrace{α ( s , \{ {s}^{′} ∈ S \vert {s}^{′} . pcp > s . pcp \} ) +}}_{{d}_{inter - class , >}^{S}} {\underbrace{α ( s , \{ {s}^{′} ∈ S \vert {s}^{′} . pcp == s . pcp \} )}}_{{d}_{intra - class}^{S}} + {\underbrace{{\sum }_{e ∈ {s}_{path}} {d}_{t r a n s} ( e , MFU + IFG )}}_{{d}_{inter - class , <}^{S}}$$

3. Frame Preemption: FP has no time reference. Therefore, the combination of FP with one of the other mechanisms requires time synchronization of the network. In the following considerations, we assume that the cycle time is sufficiently large so that all FP streams can be delivered within a cycle time. In order to combine FP and exclusive gating-based approaches, we need to calculate d^{s}_{gate} to the worst-case calculation;

$${d}_{e 2 e}^{S} = {d}_{p a t h}^{S} + {d}_{g a t e}^{S} + {\underbrace{α ( s , \{ {s}^{′} ∈ S \vert {s}^{′} . pcp > s . pcp \} ) +}}_{{d}_{inter - class , >}^{S}} {\underbrace{α ( s , \{ {s}^{′} ∈ S \vert {s}^{′} . pcp == s . pcp \} )}}_{{d}_{intra - class}^{S}} + {\sum }_{e ∈ {s}_{path}} max ( {d}_{inter - class , {<}_{e}}^{s} ( e ) , {d}_{inter - class , {<}_{p}}^{S} ( e ) )$$

The stream-based scheduling and class-based scheduling with exclusive gating have in common that, in both approaches, the gates of all other traffic classes are closed for a particular time during the cycle. The stream-based scheduling closes the gates for the time it takes to transmit its streams. The actual gate delay depends on the implementation of the scheduling algorithm. We can have B for example take the time required to transmit all stream-based streams including a security margin at the edge with the highest load:

$${d}_{gate}^{S} = {max}_{e ∈ ε} ( {\sum }_{{s}^{′} ∈ {S}_{stream - based \vert e ∈ {s}_{path}^{′}}} {d}_{t r a n s} ( e , {s}_{size}^{′} + safety ) )$$

In class-based scheduling with exclusive gating, the gate delay corresponds to t_{window}. In the case of class-based scheduling without exclusive gating, the interference term of the FP streams has to take into account the class-based streams taking into account the Traffic priorities and preemption markers must be taken into account.

LIST OF REFERENCE SIGNS

One 2, 3, 4-network user
5 Propagation delay
6 Transmission delay
7 Processing delay
8 Queue delay
9 IFG
t Time
10 Switch logic
11 Preemption Transmission Selection (TSA)
12 Express Transmission Selection (TSA)
13 Ethernet link
14 TAS
15 Frame preemption
16 Input Point (Input)
17 Output point (Output)
Q0, Q1, Q2 . . . Q7 queues
C Gate
30 Increasing gaps
s, s′ s″, s′″ data streams
50 Time window
51 Open
52 Cycle
53 Arrival of data stream s

1. A method for improving scheduling in a time-critical networks having a computer network and a plurality of network users, the method comprising the steps of:
grouping at first some or all of the network users along a transmission path from a network user acting as a transmitter to a network user acting as a receiver,
calculating the longest possible transfer time of a data stream between any two network users along the transmission path according to one interference model or an end-to-end model,
calculating the longest possible transfer time between transmitter and receiver by summing the calculated transfer times, and
using this calculated transfer time between transmitter and receiver as the basis for time scheduling in the network.

2. The method according to claim 1, wherein competing data streams on the same transmission path are used as the basis for the interference model.

3. The method according to claim 2, wherein network switches operated in a store-and-forward operating mode are used for the interference model.

4. The method according to claim 2, wherein network switches operated in a cut-through operating mode are used for the interference model.

5. The method according to claim 1, wherein a physical path delay is taken into account for the end-to-end model.

6. The method according to claim 1, wherein scheduling of the time-critical network takes place in a data stream-based manner.

7. The method according to claim 6, wherein an embedded time slot is assigned to each data stream,

8. The method according to claim 1, wherein scheduling of the time-critical network is traffic-class based.

9. The method according to claim 8, wherein competing data streams of the same network class are taken into account.

10. The method according to claim 1, wherein scheduling of the time-critical network takes place according to frame preemption.

11. The method according to claim 10, wherein data streams are sent in a prioritized manner.

12. The method according to claim 1, wherein scheduling can takes place by data stream-based, class-based or after-frame preemption.

13. The method according to claim 1, wherein the networks are in ring topology or line topology.

14. The method defined in claim 1, wherein each network user has a processor and a memory that can carry out a method according to claim 1.

15. The method defined in claim 14, wherein scheduling of the network users is carried out on the basis of results of the method by one of the users.
